(19) United States
(12) Patent Application Publication
(10) Pub. No.: US 2024/0377918 A1
(43) Pub. Date: Nov. 14, 2024

(54) INFORMATION PROCESSING SYSTEM

(71) Applicant: CANON KABUSHIKI KAISHA, Tokyo (JP)

(72) Inventors: MASAHIKO OKUZAWA, Kanagawa (JP); HIROYUKI WATABE, Tokyo (JP)

(21) Appl. No.: 18/616,415

(22) Filed: Mar. 26, 2024

(30) Foreign Application Priority Data
May 12, 2023 (JP) 2023-079405

(51) Int. Cl. G06F 3/04815; G06F 3/04812

(52) U.S. Cl. CPC G06F 3/04815; G06F 3/04812

(57) ABSTRACT

An information processing system includes: a processor; and a memory storing a program that, when executed by the processor, causes the processor to generate a first image representing a view from a viewpoint of a first user on a virtual three-dimensional space shared by a plurality of users, synthesize an indication user interface (UI) used by each user to indicate a point in the three-dimensional space with the first image, determine visibility of an indicated position of a second user when seen from the viewpoint of the first user, the indicated position being a point in the three-dimensional space that is indicated by the second user through the indication UI, and change a method for displaying the indication UI of the second user in the first image according to a determination result of the visibility.

### BACKGROUND OF THE INVENTION

### Field of the Invention

The present invention provides an information processing system.

### Description of the Related Art

Conventionally, there have been systems that connect computers to each other via a local area network (LAN) or the like and enable participation of a plurality of persons in online meetings. As one of the functions of online meetings, a screen sharing function with which a plurality of participants are enabled to share the same display screen and perform an operation in real time and at the same time has been known. For example, Japanese Patent Application Laid-open No. H3-119478 has proposed a technology to display a position (indicated position) of each user through a pointer and make it possible to visually and easily distinguish the indicated positions of the respective users.

In recent years, space sharing systems that use technologies such as virtual reality (VR) and mixed reality (MR) and enable a plurality of users to share virtual three-dimensional spaces have also been emerged. Since a three-dimensional space also includes information on a depth direction, there is a situation in which an indicated position of one user is on a back side (dead angle) of an object when seen from another user. Therefore, even if the technology disclosed in Japanese Patent Application Laid-open No. H3-119478 is directly applied to a three-dimensional space, there is a possibility that a pointer of another user is not visually recognizable and that an indicated position of the other user is not perceivable.

In order to solve this problem, there has been a method for displaying a ray directed from a position (for example, a hand position or a viewpoint position) of a user toward an indicated position of the user on a VR or MR display screen. Even if an indicated position of another user is occluded by an object and is therefore not seen, it is possible to approximately recognize a position indicated by the user through display of a ray extending from the user.

However, a ray occupies a larger area in a space than a pointer. Therefore, if all rays are displayed when a plurality of persons perform an operation, there is a problem that visibility is degraded since a ray of another user becomes obstructive.

Further, since a large stuff such as a vehicle and heavy machinery is used to be displayed as computer graphics (CG) in VR or MR, an indicated position may be at a place distant from another user. In such a case, there is a possibility that an indicated position is hardly seen from the other user since a pointer is small. However, even if the pointer is made large so as to be seen from the distant user, there is a problem that a person at a place near the indicated position hardly sees the CG since the pointer becomes obstructive.

### SUMMARY OF THE INVENTION

The present invention has been made in order to solve the above problems and provides a technology capable of achieving both easiness of grasping an indicated position of another user and prevention of a reduction in visibility in an operation on a three-dimensional space.

The present disclosure includes an information processing system including: a processor; and a memory storing a program that, when executed by the processor, causes the processor to generate a first image representing a view from a viewpoint of a first user on a virtual three-dimensional space shared by a plurality of users, synthesize an indication user interface (UI) used by each user to indicate a point in the three-dimensional space with the first image, determine visibility of an indicated position of a second user when seen from the viewpoint of the first user, the indicated position being a point in the three-dimensional space that is indicated by the second user through the indication UI, and change a method for displaying the indication UI of the second user in the first image according to a determination result of the visibility.

Further features of the present invention will become apparent from the following description of exemplary embodiments with reference to the attached drawings.

### BRIEF DESCRIPTION OF THE DRAWINGS

FIG. 1 is a block diagram showing a configuration example of an information processing system according to a first embodiment;

FIGS. 2A and 2B are views for describing an operation device according to the first embodiment;

FIG. 3 is a view for describing an indicated direction using the operation device according to the first embodiment;

FIG. 4 is a flowchart showing an operation of the information processing system according to the first embodiment;

FIG. 5 is a view for describing display of rays according to the first embodiment;

FIG. 6 is a block diagram showing a configuration example of an information processing system according to a second embodiment;

FIG. 7 is a view showing a magnetic-field sensor system;

FIG. 8 is a block diagram showing the hardware configuration of the information processing system;

FIG. 9 is a flowchart showing an operation of the information processing system according to the second embodiment;

FIG. 10 is a view showing a method for determining an indicated position;

FIGS. 11A and 11B are views showing an expression example of an indicated position;

FIGS. 12A and 12B are views showing a method for determining whether an indicated position is seen; and

FIG. 13 is a flowchart showing an operation of the information processing system according to the second embodiment.

### DESCRIPTION OF THE EMBODIMENTS

The present invention relates to a space sharing system in which a plurality of users share a virtual three-dimensional space, and more specifically, to a technology to improve a method for displaying positions or directions indicated by respective users in a virtual three-dimensional space. A technology to merge a real world and a virtual world is called cross reality (XR), and the XR includes virtual reality (VR), augmented reality (AR), mixed reality (MR), substitutional reality (SR), or the like. The present invention is applicable to any type of XR content.

In embodiments of the present invention that will be described below, users participate in a space sharing system using an information processing system. The information processing system is a device individually possessed and operated by each of the users, and may be therefore called an information terminal, a user terminal, a client device, an edge, an XR terminal, or the like. Note that the configuration of the space sharing system includes a server-client system in which the information processing systems of the respective users access a central server, a P2P system in which the information processing systems of the respective users communicate with each other in a peer-to-peer fashion, or the like, but the space sharing system may have any of the configurations.

For example, it is assumed that a first user and a second user share a virtual three-dimensional space. In a first information processing system operated by the first user, a first image representing a view from a viewpoint of the first user is generated as an image shown to the first user. Similarly, in a second information processing system operated by the second user, a second image representing a view from a viewpoint of the second user is generated as an image shown to the second user. At this time, the viewpoints are different even if the first user and the second user see the same object O in the three-dimensional space. Therefore, the first image and the second image are different, and the appearance of the object O becomes different.

For example, a case where the first user and the second user discuss while indicating details about the object O will be assumed. The respective users use an indication user interface (UI) to indicate a point in the three-dimensional space. The indication UI may include, for example, a pointer representing a point (indicated position) in the three-dimensional space that is indicated by the users and a ray representing a direction (indicated direction) indicated by the users. Here, when the first information processing system superimposes not only the indication UI of the first user (user oneself) but also the indication UI of the second user (another person) on the first image, the first user is enabled to visually recognize the indicated position or the indicated direction of the second user (the other person). Similarly, when the second information processing system superimposes the indication UI of the first user on the second image, the second user is also enabled to visually recognize the indicated position or the indicated direction of the first user. Thus, the respective users are enabled to recognize the indicated positions or the indicated directions each other in the virtual three-dimensional space.

However, as described in the conventional problem, there is a possibility that the ray or the pointer of another user reduces visibility of the object O or causes visual botheration or a sense of disturbance. Further, in a case where the users are distant from each other or indicate remote places, there is a possibility that discrimination of the places indicated by the indication UIs becomes difficult. Such a problem will become remarkable when a larger number of users participate in the space sharing system.

Therefore, the first information processing system performs UI display control to determine visibility of the indicated position of the second user when seen from the viewpoint of the first user and change a method for displaying the indication UI of the second user in the first image according to a result of the determination. Similarly, the second information processing system performs UI display control to determine visibility of the indicated position of the first user when seen from the viewpoint of the second user and change a method for displaying the indication UI of the first user in the second image according to a result of the determination. By adaptively controlling UI display according to the visibility as described above, it is possible to achieve both easiness of grasping an indicated position of another user and prevention of a reduction in the visibility. A specific example of changing the method for displaying the indication UIs will be described in detail in the following embodiments.

Note that the indicated directions (directions of the rays) or the indicated positions (positions of the pointers) may be operated in any method. For example, the indicated directions or the indicated positions of the users may be specified by detecting positions and orientations of operation devices attached to or held by hands of the users. Alternatively, the indicated directions or the indicated positions of the users may be specified by recognizing directions or shapes of hands or fingers of the users according to a hand tracking technology using a camera. Alternatively, the indicated directions or the indicated positions of the users may be specified by detecting visual lines or gazing points of the users. Moreover, these operation methods may be combined together or changed according to circumstances.

### First Embodiment

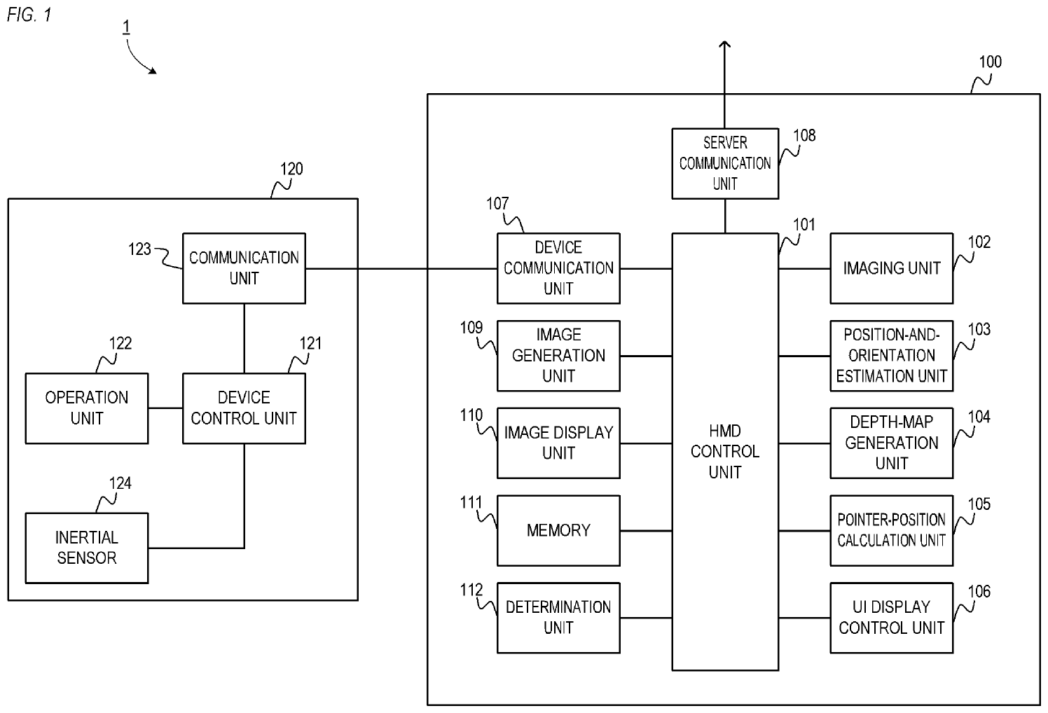

Hereinafter, an information processing system according to a first embodiment will be described with reference to the configuration diagram of FIG. 1. An information processing system 1 has a head-mounted display (HMD) 100 and an operation device 120.

The HMD 100 is a head-mounted display device (electronic equipment) capable of being attached to the head of a user. The HMD 100 has an HMD control unit 101, an imaging unit 102, a position-and-orientation estimation unit 103, a depth-map generation unit 104, a pointer-position calculation unit 105, a UI display control unit 106, and a determination unit 112. In addition, the HMD 100 has a device communication unit 107, a server communication unit 108, an image generation unit 109, an image display unit 110, and a memory 111. The HMD control unit 101 controls the respective configurations of the HMD 100.

The imaging unit 102 may include two cameras (imaging devices). In order to capture the same video as that seen by a user with naked eyes (with the HMD 100 not attached thereto), the two cameras are arranged near positions of the left and right eyes of the user wearing the HMD 100. Images of an object (a range in front of the user) captured by the two cameras are output to the image generation unit 109 and the position-and-orientation estimation unit 103. The first embodiment will describe a configuration in which an image is shared between the image generation unit 109 and the position-and-orientation estimation unit 103. However, a plurality of other cameras may be further installed just like when the image generation unit 109 and the position-and-orientation estimation unit 103 use different cameras.

The position-and-orientation estimation unit 103 receives images captured by the two cameras of the imaging unit 102, and estimates a position and an orientation of the HMD 100 by visual simultaneous localization and mapping (SLAM). Information on the estimated position-and-orientation is transmitted to the image generation unit 109.

The depth-map generation unit 104 generates a depth map. The depth map is used to express information on a depth in a three-dimensional space. The depth-map generation unit 104 acquires information on a distance to an object in a reality space or a CG content displayed in a superimposed fashion with a viewpoint position of a user as a reference, and generates a depth map. The information on the distance to the object in the reality space is calculatable from, for example, a parallax between two images captured by the imaging unit 102. As a method for calculating the information on the distance from the two images, an existing technology is available. A method for generating the depth map is not limited to the above but may be performed using other methods such as a method using light detection and ranging (LiDAR).

The pointer-position calculation unit 105 calculates a position indicated by a pointer. Indication of a position in a mixed-reality space may be performed using the operation device 120 associated with the HMD 100 in advance. Details about the operation device 120 will be described later. When a user performs an operation to indicate an object in a reality space or CG using the operation device 120, the pointer-position calculation unit 105 calculates an indicated direction of the user from a position and an orientation of the operation device 120 acquired via the device communication unit 107. The pointer-position calculation unit 105 specifies an indicated direction calculated from information on the position and the orientation of the operation device 120 and a position indicated on a three-dimensional space from a depth map described above.

The determination unit 112 determines visibility of an indicated position of another user when seen from a viewpoint of a user oneself. Specifically, the determination unit 112 determines whether a pointer position of another user is at a place seen from a user oneself on the basis of information on the pointer position of the other user obtained via the server communication unit 108 and a depth map generated by the depth-map generation unit 104. The UI display control unit 106 generates information on a method for displaying a pointer and a ray according to a determination result of the determination unit 112.

The device communication unit 107 performs wireless communication with the operation device 120. Via wireless communication, the HMD 100 acquires information on an operation of a button or the like of the operation device 120 or information on a sensor installed in the operation device 120. For communication with the operation device 120, Bluetooth (registered trademark), a wireless LAN, or the like is used.

The server communication unit 108 performs communication with a server. For communication with the server, a wireless LAN or the like is used. The present embodiment assumes a use mode in which a plurality of users gather together at the same place in a reality space to participate in (connect to) the server and share one mixed-reality space. The server communication unit 108 performs transmission and reception of necessary information such as information on a position of another participating user via the server. Further, in order to make an indicated position of another user displayable by a pointer when a plurality of users perform an operation in a mixed-reality space, the HMD 100 transmits information on a position and an orientation of the own operation device 120 and an indicated position or operated information to the server, and receives information on the other user from the server.

The image generation unit 109 generates a synthetic image representing a mixed-reality space by synthesizing images acquired from the imaging unit 102 and a content such as CG together. A viewpoint of CG is determined by acquisition of information on a position and an orientation estimated by the position-and-orientation estimation unit 103. The first embodiment will describe an example in which a synthetic image representing a mixed-reality space is generated. However, an image representing a virtual-reality space composed of CG only may be generated. In addition, the image generation unit 109 synthesizes CG of a pointer and CG of a ray together according to information on the operation device acquired via the device communication unit 107 and information generated by the UI display control unit 106.

The image display unit 110 displays an image generated by the image generation unit 109. The image display unit 110 has, for example, a liquid-crystal panel, an organic EL panel, or the like. When a user wears the HMD 100, the image display unit 110 is arranged for each of the right eye and the left eye of the user.

The memory 111 is a storage medium that retains various data necessary for performing processing in the HMD 100. The data retained in the memory 111 includes, for example, information on a user or information on an indicated position acquired by the server communication unit 108, information on a sensor of the operation device 120 received by the device communication unit 107, or the like.

The present embodiment will describe an example in which the present invention is applied to the HMD 100 of a head-mounted type. However, the configuration of the present invention is not limited to an HMD. For example, the present invention may be applied to, for example, personal computers, smart phones, tablet terminals, or the like including a display and a camera. Further, an information processing unit (information processing device) responsible for performing image processing and information processing is embedded in the HMD 100 in the present embodiment. However, the information processing unit (information processing device) may be provided separately from the HMD 100.

### Configuration of Operation Device

Next, the internal configuration of the operation device 120 will be described with reference to FIG. 1. The operation device 120 is a device for inputting a command to the HMD 100, and can be a control device for controlling the HMD 100 through a user operation. The operation device 120 has a device control unit 121, an operation unit 122, a communication unit 123, and an inertial sensor 124.

The device control unit 121 controls the respective configurations of the operation device 120. The operation unit 122 is an operation unit such as a button operated by a user. The communication unit 123 transmits operation information on the operation unit 122 and sensor information acquired by the inertial sensor 124 to the HMD 100 via wireless communication. The inertial sensor 124 is an inertial measurement unit (IMU), and acquires a three-dimensional angular speed and acceleration as sensor information. In addition, the inertial sensor 124 may include a geomagnetic sensor or a plurality of angular speed sensors.

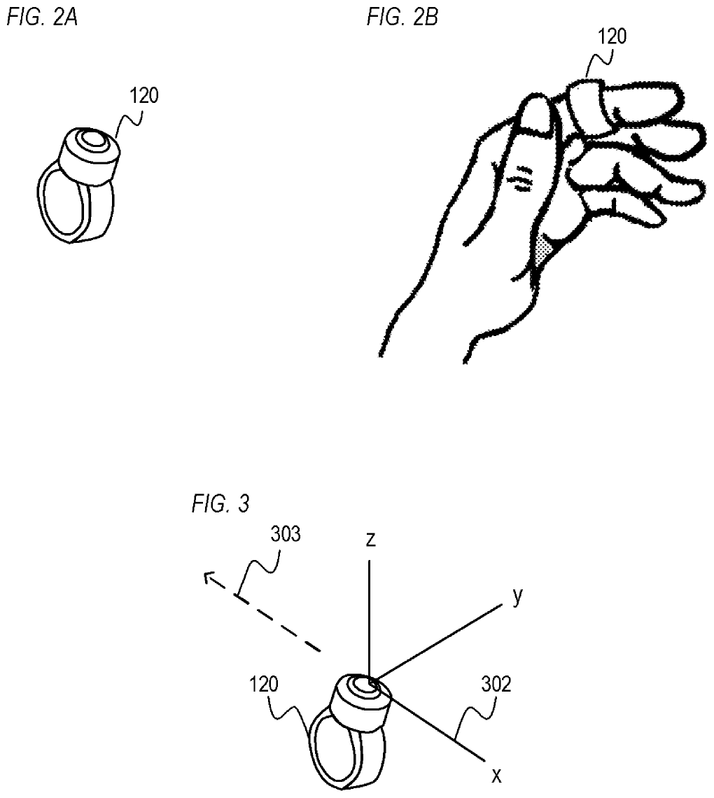

The operation device 120 is also called a “hand controller” or simply a “controller.” A type having a shape gripped (held) by a hand of a user is called a grip-type controller, a hand-held-type controller, or the like, and a type used in a state of being attached to a hand or a finger of a user is called a wearable-type controller or the like. In the present embodiment, a ring-type operation device 120 attachable to a finger of a user is used as shown in, for example, FIGS. 2A and 2B. If the operation device 120 is attachable to a finger of a user, there is an advantage that the user is capable of freely moving the hand or the finger while holding the operation device 120, and that hiding of the hand due to the operation device 120 hardly occurs.

Note that the shape of the operation device 120 is a ring type here but is not limited to this. For example, the shape of the operation device 120 may be a shape such as a grove type attachable to a hand or a shape such as wristwatch type (bracelet type) attachable to a wrist. As described above, the operation device 120 may have such a form as to be capable of being held by a hand of a user or a form attachable to a hand or a wrist so as to be easily used by the user. A plurality of operation devices for operating the HMD 100 may be provided. For example, an operation device for a right hand and an operation device for a left hand may be separately provided, or operation devices may be attached to a plurality of fingers (for example, a thumb, an index finger, or the like), respectively.

The operation unit 122 may be composed of any operation member operated by a user through physical contact. For example, the operation unit 122 may have an optical track pad (OTP) capable of detecting a planar movement amount. Further, the operation unit 122 may include any of a touch pad, a touch panel, a cross key, a button, a joystick, and a track pad device. Alternatively, the operation unit 122 may be eliminated if only a change in a position and/or an orientation of the operation device 120 itself is used as an operation by the operation device 120.

### Display of Ray

A pointer operation using the operation device 120 will be described with reference to FIG. 3.

As shown by symbol 302 in FIG. 3, an operation-device coordinate system (xyz orthogonal coordinate system) is defined with a position and an orientation of the operation device 120 as a reference. The HMD control unit 101 receives sensor data acquired by the inertial sensor 124 from the operation device 120 via the device communication unit 107 and the communication unit 123, and calculates an orientation of the operation device 120 on the basis of the sensor data. For calculation of the orientation of the operation device 120, a known technology may be used. Further, a position of the operation device 120 is specified by a method such as specifying the position of the operation device 120 according to image recognition using images acquired by the imaging unit 102 of the HMD 100. As a method for specifying the position of the operation device 120 according to image recognition, a known technology such as machine learning may be used.

The HMD 100 stores a setting value in an indicated direction of the operation device 120. As shown in, for example, FIG. 3, an indicated direction 303 is set parallel to an x-axis (negative direction) of the operation-device coordinate system. In this manner, a user is enabled to indicate a distant position according to movement of a hand to which the operation device 120 is attached.

In the first embodiment, the image generation unit 109 synthesizes CG of a ray extending from the operation device 120 along the indicated direction 303 and CG of a pointer indicating an indicated position together so that a user is enabled to easily recognize a position of the pointer. The ray is an CG object linearly extending along the indicated direction 303 like irradiation of light from the operation device 120. The pointer is a CG object representing a tip-end portion (an intersecting point between the ray and an object (an object in a reality space or a virtual object by CG)) of the ray. Display of Pointer and Ray of Another User

In the first embodiment, participating users wear the HMD 100 and the operation device 120 in the information processing system 1, and communicate with each other via the server. In such a situation, display of a pointer and a ray is performed in such a manner as to let another participating user know an indicated position when each of the users indicates an object on a mixed-reality space.

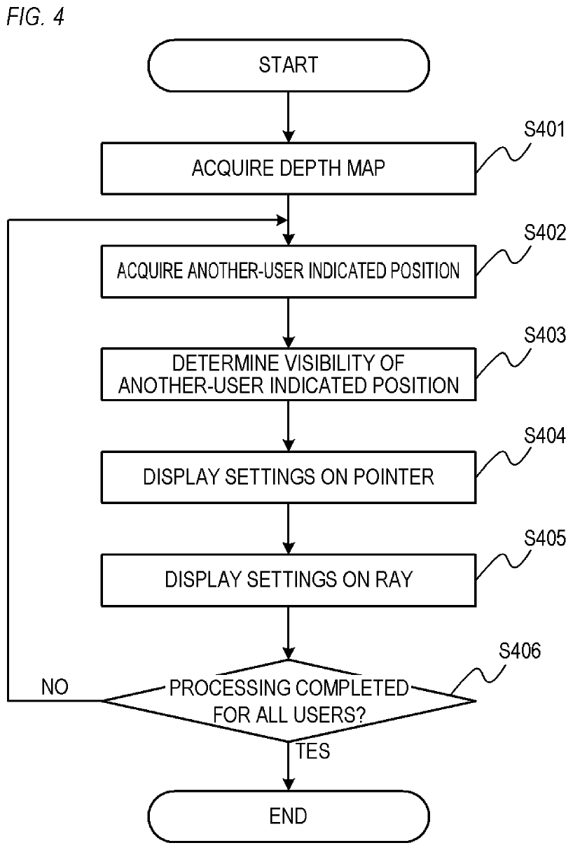

Processing of the determination unit 112 and the UI display control unit 106 relating to display control of a pointer and a ray will be described in detail with reference to the flowchart of FIG. 4.

In step S401, the determination unit 112 acquires a depth map generated by the depth-map generation unit 104 with a present viewpoint position of a user oneself as a reference from the memory 111.

Processing of subsequent steps S402 to S405 is performed for each of the participating users other than the user oneself. In the following description, a participating user selected as a processing target will be called a “target user.”

In step S402, the determination unit 112 reads data of a target user that is acquired in advance via the server communication unit 108 from the memory 111, and acquires information on a position (hereinafter called an “another-user indicated position”) indicated by the target user.

In step S403, the determination unit 112 determines whether the another-user indicated position is at a place seen from a viewpoint of the user oneself. The determination unit 112 determines that visibility of the another-user indicated position is good when the another-user indicated position is at the place seen from the viewpoint of the user oneself, and determines that the visibility of the another-user indicated position is poor when the another-user indicated position is at a place not seen from the viewpoint of the user oneself. Specifically, the determination unit 112 calculates a projected position obtained when the another-user indicated position acquired in step S402 is projected on a screen on which a view of the user oneself is displayed. Then, the determination unit 112 determines whether the another-user indicated position is on a front side or a back side (dead angle) of an object present within the view of the user oneself by comparing the calculated projected position with information on the depth of the position concerned in the depth map acquired in step S401. The determination unit 112 determines that the another-user indicated position is at the place seen from the viewpoint of the user oneself (the visibility is good) when the another-user indicated position is on the front side of the object, and determines that the another-user indicated position is at the place not seen from the viewpoint of the user oneself (the visibility is poor) when the another-user indicated position is on the back side of the object. As described above, the visibility of the another-user indicated position may be determined using the depth map.

In step S404, the UI display control unit 106 performs display settings on a pointer. When it is determined in step S403 that the another-user indicated position indicates the place seen from the viewpoint position of the user oneself, the UI display control unit 106 performs settings to display the pointer. Otherwise, the UI display control unit 106 performs settings so as not to display the pointer. By hiding the pointer in a case where the another-user indicated position indicates the place not seen from the viewpoint position of the user oneself, false recognition of the another-user indicated position is prevented. In addition, the UI display control unit 106 performs settings on a method for displaying the pointer. The settings on the method for displaying the pointer include, for example, settings on a color and a shape of the pointer, settings on text (annotation) displayed near the pointer, or the like. With a change in the method for displaying the color, the shape, the text, or the like of the pointer for each user, a distinction between users is enabled by the pointer. In the present embodiment, the pointer is not displayed when the another-user indicated position indicates the place not seen from the viewpoint position of the user oneself. However, display of a pointer is not limited to such control. For example, a pointer may be displayed in a semi-transparent state. Like this, a display method different from usual pointer display may be employed to indicate an invisible position. Further, in a case where a pointer is superimposed on a ray as a result of display of the ray, a color or a size of the pointer may be highlighted so as to make the pointer easily seen.

In step S405, the UI display control unit 106 performs display settings on a ray. The UI display control unit 106 performs settings so as not to display the ray of the target user when the indicated position of the target user is seen from the viewpoint position of the user oneself. Thus, it is possible to prevent a reduction in visibility such as a difficulty in seeing a CG content due to an increase in the number of rays inside the screen. Note that hiding of the ray of the target user does not cause a significant problem since the indicated position of the target user is recognizable as a result of the display settings on the pointer in step S404.

On the other hand, the UI display control unit 106 performs settings to display the ray when the indicated position of the target user is not seen from the viewpoint position of the user oneself. Thus, it is possible to grasp an approximate indicated direction with respect to the indicated position not seen from the viewpoint position of the user oneself.

In step S406, the UI display control unit 106 determines whether the processing of steps S402 to S405 has been performed for each of the users other than the user oneself. If the processing has not been performed for all the users, the UI display control unit 106 selects an unprocessed user as a target user and returns to step S402. When the processing has been completed for all the users, the UI display control unit 106 ends the processing.

### Alternative Method for Displaying Pointer and Ray

When an indicated position of another user is at a place near a boundary between a region where the indicated position is seen from a viewpoint of a user oneself and a region where the indicated position is not seen from the viewpoint of the user oneself, there is a case that the indicated position of the other user frequently comes across the boundary as a hand of the other user shakes or a viewpoint position of the user oneself shifts. In this case, switching of display frequently occurs between a pointer and a ray in the basic operation of the UI display control unit 106 described above, which results in occurrence of a reduction in visibility or visual botheration. In order to solve such a problem, the UI display control unit 106 may change a method for displaying a pointer or a ray of another user at the time point when the same determination result is continued for a predetermined time after a determination result of the determination unit 112 is changed.

For example, in the processing of steps S404 and S405, the ray may remain hidden for a predetermined time (for example, about several hundred milliseconds to several seconds) even in a case where the another-user indicated position moves from the place not seen from the viewpoint position of the user oneself to the place seen from the viewpoint position thereof. Further, the settings on the display methods in the processing of steps S404 and S405 are not limited to the above. As a display method at the place near the boundary, a display setting in which both the ray and the pointer are displayed for a predetermined time after the indicated position has come across the boundary may be performed. A user may set a length of the predetermined time.

In addition, an indication UI such as a ray and a pointer may be displayed only when a predetermined operation is being performed, just like a case where a ray is displayed for only a period in which a user operates the operation unit 122 of the operation device 120. Thus, the user is enabled to display a ray or a pointer through a predetermined operation in a case where he/she wants to confirm an indicated position or an indicated direction of another user, or enabled to hide the ray or the pointer in other cases to increase visibility of an object within a view. That is, the user is enabled to use an indication UI according to purposes.

### Second Alternative Method for Displaying Pointer and Ray

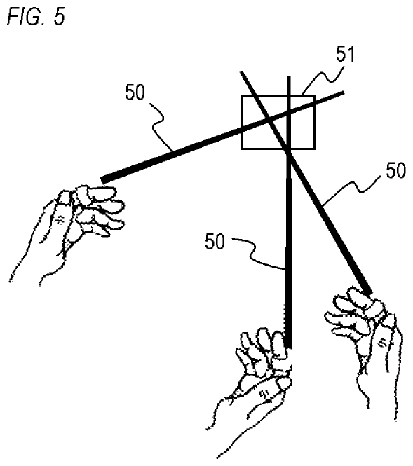

There is a case that rays are superimposed on each other or the rays and pointers are superimposed on each other when a plurality of users display the rays. In this case, there is a possibility that visibility of the rays and the pointers reduces. For example, in a situation in which a plurality of rays 50 are displayed superimposed on each other as shown in FIG. 5, there is a possibility that an object 51 displayed at the back of the rays 50 is made hardly seen about a place near a region where the rays 50 are superimposed on each other.

In order to solve such a problem, the UI display control unit 106 may change a display method in a case where rays or pointers are superimposed on each other. Specifically, the determination unit 112 acquires information on positions of the operation devices 120 of respective users and indicated positions of the respective users, and determines whether rays are displayed superimposed on each other on the basis of the information. When a result of the determination shows that at least a predetermined number of the rays are displayed superimposed on each other, the UI display control unit 106 changes a method for displaying the rays to increase, for example, the transparency of the rays to be synthesized with another CG. Here, the “predetermined number” may be set at any number of at least two. As the method for displaying the rays, other methods such as displaying the rays in a slender shape other than changing the transparency may be employed. A determination as to whether the rays are displayed superimposed on each other may be made by calculating coordinates obtained when the positions of the operation devices 120 of the respective users and the indicated positions of the respective users are projected on the screen and determining whether lines connecting the operation devices 120 and the indicated positions cross each other.

Further, there is a case that visibility reduces in a situation in which a pointer displayed at an indicated position is displayed superimposed on a ray of another user. When a pointer is superimposed on a ray of another user, the UI display control unit 106 may set an indicated position so as to be easily recognizable by a method such as changing a size of the pointer and highlighting a color of the pointer.

### Third Alternative Method for Displaying Pointer and Ray

The first embodiment describes an example in which participating users gather together at the same place and perform an operation. However, a user may be enabled to participate in a system from a distant place by remote control. The user participating in the system by remote control is mapped at a predetermined position on a mixed-reality space or a virtual space. In such a situation, a position of the user participating in the system by remote control is not directly seen from another participating user. Therefore, CG (such as an avatar) may be displayed at the position of the user on the basis of information on the user acquired via the server communication unit 108 to be known by the other user.

Further, since it is preferable to grasp a starting point of an operation at the time of displaying a pointer or a ray to let another user know an indicated position, CG of the operation device 120 may be displayed at a predetermined position of a hand of a user.

In addition, in the processing of the UI display control unit 106, colors of CG of the operation device 120 and a pointer may be made identical, and the colors may be made different for each user to devise display so that correspondence between the users and the pointers is visible.

As described above, in the first embodiment, a method for displaying a pointer or a ray of another participating user is changed depending on whether an indicated position of the other participating user is seen from a viewpoint position of a user oneself. Therefore, it is possible to provide a display method by which grasping of an indicated position is easy regardless of the indicated position of another user and visibility does not reduce.

### Second Embodiment

In the first embodiment, a determination is made as to whether an indicated position is seen on the basis of a positional relationship between a depth map of an object in a reality space or a CG content displayed in a superimposed fashion and the indicated position of another user, and a method for displaying a pointer and a ray is changed. A second embodiment will describe an example of an information processing device that makes a change to expression of a pointer or a CG content at an indicated position according to a distance between a viewpoint position of a user oneself and the indicated position of another user.

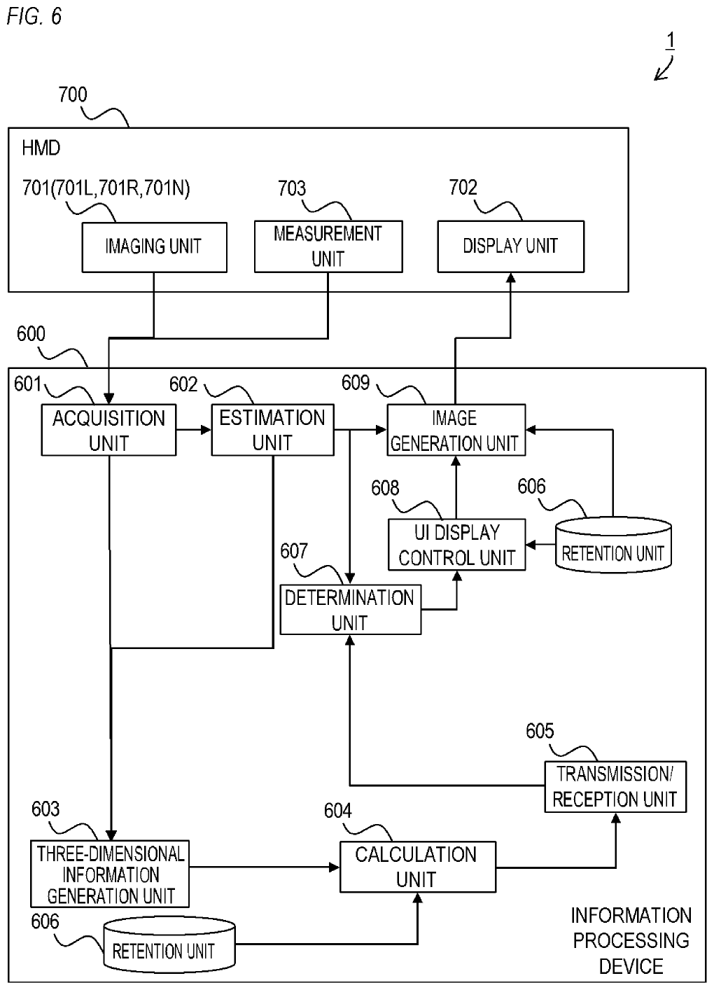

First, a configuration example of an information processing system according to the second embodiment will be described with reference to the block diagram of FIG. 6. An information processing system 1 according to the present embodiment has an HMD 700 and an information processing device 600 as its hardware. The HMD 700 and the information processing device 600 are connected so as to be capable of performing data communication each other in a wired and/or wireless fashion.

The HMD 700 will be described. A user who acts as an observer is enabled to observe a virtual-reality space or a mixed-reality space via the HMD 700 by wearing the HMD 700 on his/her head. Note that the HMD 700 is shown as an example of a head-mounted display device in the present embodiment. However, other types of head-mounted display devices may be applied. Further, besides the head-mounted display devices, other types of display devices such as, for example, hand-held display devices may be applied so long as the display devices are viewed by observers to observe a virtual-reality space or a mixed-reality space.

A display unit 702 displays an image of a virtual-reality space or a mixed-reality space that is transmitted from the information processing device 600. The display unit 702 may be configured to include two displays arranged corresponding to left and right eyes of an observer. In this case, an image of a virtual-reality space or a mixed-reality space for the left eye is displayed on a display corresponding to the left eye of the observer, and an image of the virtual-reality space or the mixed-reality space for the right eye is displayed on a display corresponding to the right eye of the observer.

An imaging unit 701 captures moving images of a reality space, and has an imaging unit (right imaging unit) 701R that captures an image to be presented to a right eye of an observer and an imaging unit (left imaging unit) 701L that captures an image to be presented to a left eye of the observer. Images (images of the reality space) of respective frames constituting moving images captured by the imaging units 701R and 701L are sequentially transmitted to the information processing device 600. In the case of a system that observes a virtual-reality space, the imaging unit 701 may not transmit moving images of the reality space to the information processing device 600. In order to calculate a position and an orientation of the imaging unit 701, an imaging unit (a position-and-orientation calculation imaging unit) 701N for capturing moving images in the reality space that is different from the right imaging unit 701R and the left imaging unit 701L may be provided. A relative positional relationship between the position-and-orientation calculation imaging unit 701N and the right imaging unit 701R and the left imaging unit 701L is retained in advance in the information processing device 600. Further, internal parameters (such as focal distances, principal points, and angles of view) of the respective imaging units 701N, 701R, and 701L are also retained in advance in the information processing device 600.

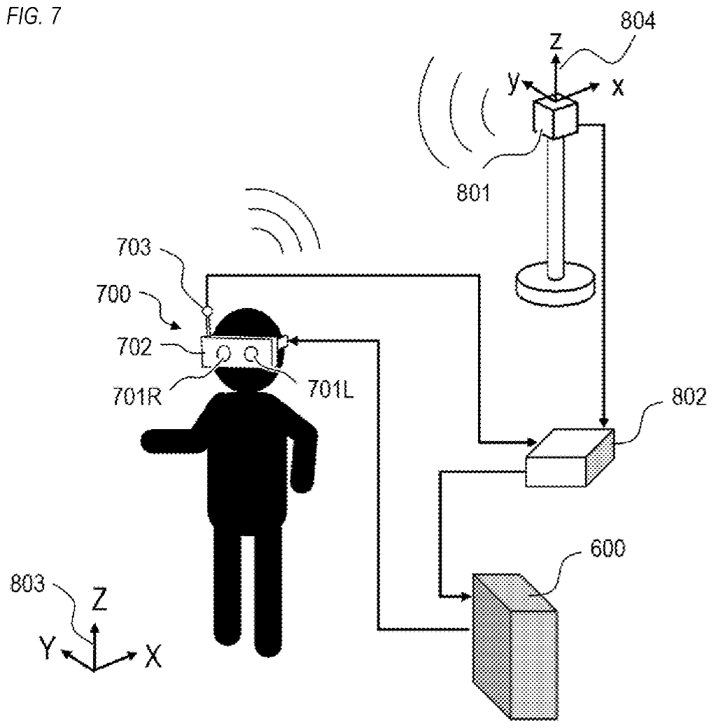

A measurement unit 703 functions as a receiver in a magnetic-field sensor system, and measures a position and an orientation thereof. The magnetic-field sensor system will be described using FIG. 7. A magnetic-field generation device 801 functions as a transmitter in the magnetic-field sensor system, is fixedly arranged at a predetermined position in a reality space, and generates a magnetic field around the magnetic-field generation device 801 itself. Operation control of the magnetic-field generation device 801 is performed by a controller 802, and operation control of the controller 802 is performed by an information processing device 600.

The measurement unit 703 is fixedly attached to the HMD 700, measures a change in a magnetic field according to a position and an orientation thereof in a magnetic field generated by the magnetic-field generation device 801, and transmits a result of the measurement to the controller 802. The controller 802 generates a signal value showing the position and the orientation of the measurement unit 703 in a sensor coordinate system 804 from the result of the measurement, and transmits the same to the information processing device 600. The sensor coordinate system 804 is a coordinate system (x, y, z) that uses a position of the magnetic-field generation device 801 as an origin and defines three axes orthogonal to each other at the origin as an x-axis, a y-axis, and a z-axis. Note that a position and an orientation of a user (HMD 700) is detected by the magnetic-field sensor system in the present embodiment. However, instead of the magnetic-field sensor system, an ultrasonic sensor system or an optical sensor system may be used, or these systems may be used in combination.

The information processing device 600 will be described. The information processing device 600 is composed of a computer device such as a personal computer (PC) or a mobile terminal device such as a smart phone and a tablet terminal device. The information processing device 600 has an acquisition unit 601, an estimation unit 602, a three-dimensional information generation unit 603, a calculation unit 604, a transmission/reception unit 605, a retention unit 606, a determination unit 607, an UI display control unit 608, and an image generation unit 609 as its main function units.

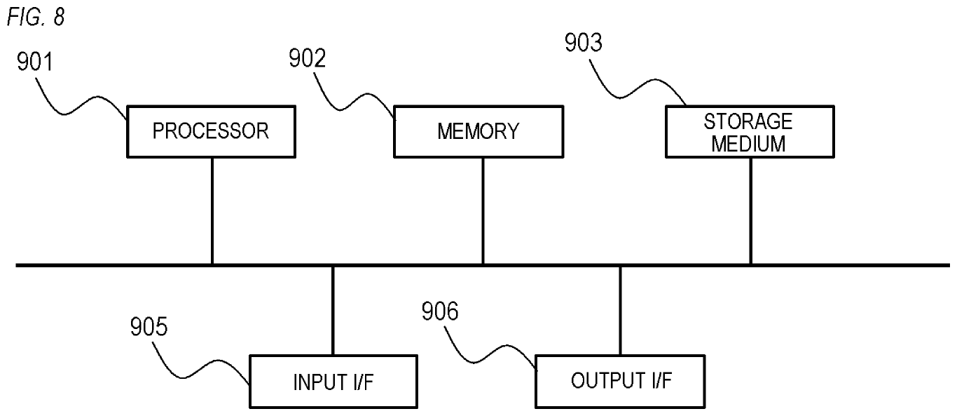

FIG. 8 is a diagram showing the basic configuration of a computer usable as the information processing device 600 according to the present embodiment. In FIG. 8, a processor 901 is, for example, a CPU and controls an entire operation of the computer. A memory 902 is, for example, a RAM and temporarily stores a program, data, or the like. A computer-readable storage medium 903 is, for example, a hard disk, a solid-state drive, or the like and non-temporarily stores a program, data, or the like. In the present embodiment, a program for implementing the functions of respective units that is stored in the storage medium 903 is read into the memory 902. Then, when the processor 901 operates according to a program on the memory 902, the functions of the respective function units that will be described below are implemented. Further, an input I/F 905 inputs an input signal from an external device in a form capable of being processed by an information processing device. Further, an output I/F 906 outputs an output signal to an external device in a form capable of being processed.

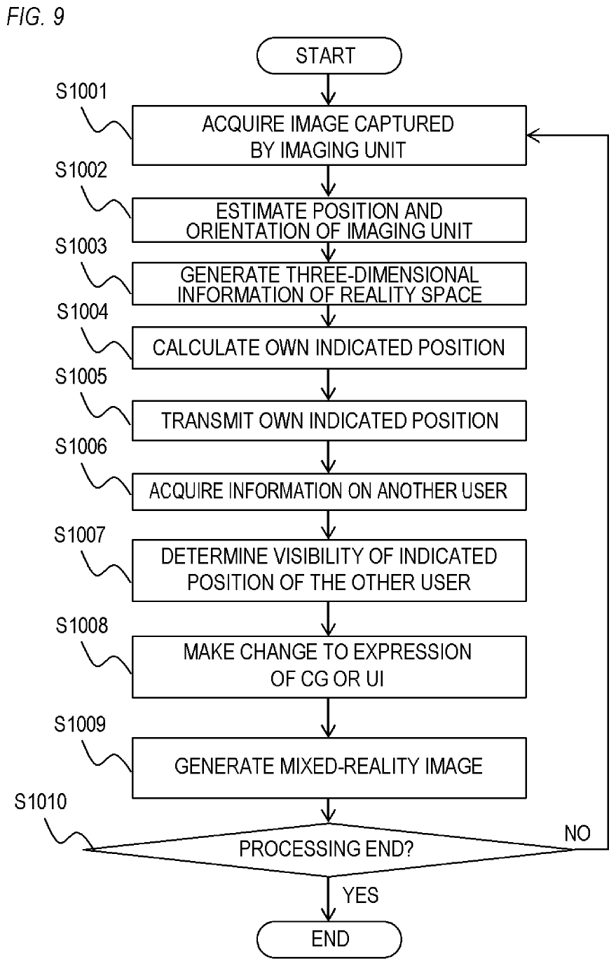

Operations of the respective function units of the information processing device 600 according to the present embodiment will be described with reference to the flowchart of FIG. 9. By the processing of the flowchart of FIG. 9, the information processing device 600 transmits an own indicated position to another user. Meanwhile, the information processing device 600 receives an indicated position of the other user, and makes a change to expression of the indicated position or a CG content according to a distance between an own viewpoint and the indicated position. Thus, both easiness of grasping the indicated position of the other user and prevention of a reduction in visibility are achieved.

In S1001, the acquisition unit 601 receives an image captured by the imaging unit 701 and a position and an orientation of the measurement unit 703 in the sensor coordinate system 804. In the case of a system that observes a virtual-reality space, the acquisition unit 601 may receive only an image captured by the position-and-orientation calculation imaging unit 701N. In the case of a system that observes a mixed-reality space, the acquisition unit 601 may receive an image captured by the right imaging unit 701R, an image captured by the left imaging unit 701L, and an image captured by the position-and-orientation calculation imaging unit 701N from the imaging unit 701.

In S1002, the estimation unit 602 uses the right imaging unit 701R and the left imaging unit 701L as a right viewpoint and a left viewpoint, respectively, and estimates positions and orientations of the right viewpoint and the left viewpoint of the HMD 700 in a world coordinate system 803. The world coordinate system 803 is an orthogonal coordinate system (X, Y, Z) that uses a reference point set on a reality space where a user (observer) is present as an origin. It is assumed that conversion information for converting positions and orientations in the sensor coordinate system 804 into positions and orientations in the world coordinate system 803 is calculated in advance and registered in advance in the information processing device 600. Further, it is assumed that a relative positional relationship (right-eye bias) between the measurement unit 703 and the right imaging unit 701R and a relative positional relationship (left-eye bias) between the measurement unit 703 and the left imaging unit 701L are also calculated in advance and registered in advance in the information processing device 600.

Specifically, the estimation unit 602 acquires a signal value showing a position and an orientation of the measurement unit 703 in the sensor coordinate system 804 (via the controller 802 in FIG. 7) from the measurement unit 703. Next, the estimation unit 602 converts the position and the orientation represented by the signal value into a position and an orientation in the world coordinate system 803 using the above conversion information. Then, the estimation unit 602 estimates a position and an orientation of the right viewpoint in the world coordinate system 803 by adding the right-eye bias to the converted position and the orientation. Similarly, the estimation unit 602 estimates a position and an orientation of the left viewpoint in the world coordinate system 803 by adding the left-eye bias to the converted position and the orientation. In a description common to the right viewpoint and the left viewpoint, the right viewpoint and the left viewpoint will be collectively and simply called a viewpoint below according to circumstances.

Note that various other methods are applicable in order to calculate a position and an orientation of the viewpoint in the world coordinate system 803. For example, a marker (also called an AR marker) allocated to the world coordinate system 803 is extracted from an image of a reality space. Then, the position and the orientation of the viewpoint in the world coordinate system 803 are calculated on the basis of a position and an orientation of the marker. The position-and-orientation calculation imaging unit 701N may extract the marker, calculate a position and an orientation of the position-and-orientation calculation imaging unit 701N in the world coordinate system 803 on the basis of the position and the orientation of the marker, and calculate the viewpoint on the basis of the relative positional relationships of the right imaging unit 701R and the left imaging unit 701L. Besides, processing of simultaneous localization and mapping (SLAM) may be performed on the basis of characteristic points reflected in an image of the reality space to calculate the position and the orientation of the viewpoint.

In S1003, the three-dimensional information generation unit 603 generates three-dimensional information from the image captured by the imaging unit 701 that is acquired by the acquisition unit 601 or the position and the orientation of the imaging unit 701 that is estimated by the estimation unit 602. The three-dimensional information is a polygon having three-dimensional positional information in the world coordinate system 803. For example, the three-dimensional information generation unit 603 is capable of calculating depths of respective pixels from parallax information in stereo images acquired from the right imaging unit 701R and the left imaging unit 701L. The three-dimensional information generation unit 603 generates three-dimensional point groups in the world coordinate system 803 from information on the depths of the respective pixels and the position and the orientation of the imaging unit 701, and generates a polygon in which the point groups are connected to each other.

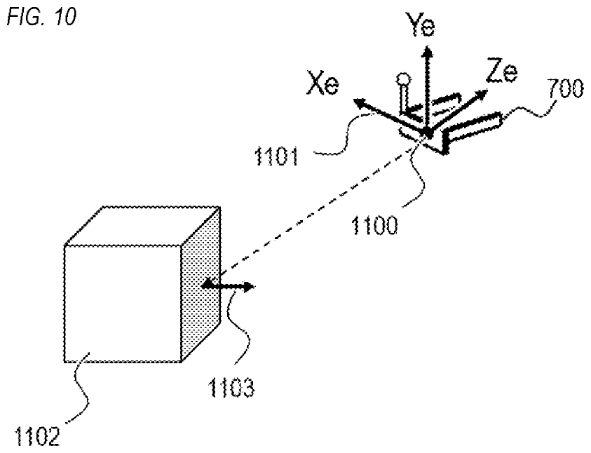

In S1004, the calculation unit 604 calculates an own indicated position. A method for calculating an indicated position will be described using FIG. 10. Symbol 1101 shows a three-dimensional orthogonal coordinate system (Xe, Ye, Ze) of the viewpoint of the HMD 700. The coordinate system 1101 of the viewpoint uses a viewpoint 1100 as an origin, and takes a Ze-axis in a direction parallel to a light axis of the imaging unit 701 and an Xe-axis and a Ye-axis in directions parallel to an image surface. In the present embodiment, an upper direction of the HMD 700 is set as a Ye-positive direction, a right-hand direction of a user is set as an Xe-positive direction, and a direction opposite to a visual line is set as a Ze-positive direction. The viewpoint 1100 is placed at a position of a right viewpoint or a left viewpoint or the center between the right viewpoint and the left viewpoint. An object 1102 shows three-dimensional information (real object) generated by the three-dimensional information generation unit 603 or a CG content (virtual object) acquired from the retention unit 606. The calculation unit 604 calculates, for example, an intersecting point between a vector in a Ze-negative direction of the coordinate system 1101 of the viewpoint and a polygon of the object 1102 as an “indicated position.” Further, the calculation unit 604 also calculates a surface-normal vector 1103 of the polygon at the indicated position. In this manner, the calculation unit 604 calculates an own indicated position. Here, the CG content acquired from the retention unit 606 includes information necessary for drawing the CG content such as polygon information that is shape information on the CG content in the world coordinate system 803, color information, information representing texture or the like, information stipulating texture, and texture.

Note that in the present embodiment, a viewpoint and a visual-line direction of a user are detected to specify a point (gazing point) on a virtual space at which the user gazes, and a UI such as a ray showing the visual-line direction (that is, an indicated direction) and a pointer showing a gazing point (that is, an indicated position) are displayed. However, a method for inputting an indicated direction and an indicated position by a user or a method for calculating the indicated direction and the indicated position of the user is not limited to this. For example, an operation device like the one described in the first embodiment may be used. That is, by detection of a position and an orientation of an operation device attached to and held by a hand of a user, it may be possible to detect an indicated direction of the user and calculate an intersecting point between a vector in the indicated direction and the object 1102 as an indicated position. Alternatively, by detection of a hand of a user, it may be possible to calculate an intersecting point between a vector of a direction pointed by an index finger and the object 1102 as an indicated position. The HMD 700 may detect a visual line of a user and calculate an intersecting point between a vector in the visual-line direction of the user and the object 1102 as an indicated position. Besides, it may be possible to detect a marker pasted on an object held by a user with a sensor such as a fixed camera, specify a vector in an indicated direction indicated by the user from a position and an orientation of the marker, and calculate an intersecting point between the vector and the object 1102 as an indicated position.

In S1005, the transmission/reception unit 605 transmits an own indicated position, a surface-normal vector at the indicated position, and a position and an orientation of a viewpoint to an information processing device of another user. A user oneself may set transmission of own information to the other user or selection of a user as a transmission destination in the information processing device 600. At this time, the user may preferably perform an operation using the operation device 120 described in the first embodiment to perform the setting in the information processing device 600.

In S1006, the transmission/reception unit 605 receives an indicated position of the other user, a surface-normal vector, and a position and an orientation of a viewpoint from the information processing device of the other user.

In S1007, the determination unit 607 calculates a distance between a position of an own viewpoint and the indicated position of the other user. Then, the determination unit 607 compares the calculated distance with a threshold. When the distance between the own viewpoint and the indicated position of the other user is at least the threshold, it is determined that visibility of the indicated position of the other user is poor (not seen or hardly seen) from the own viewpoint. When the distance is not more than the threshold, it is determined that the visibility of the indicated position of the other user is good (seen or easily seen) from the own viewpoint. The threshold may be a fixed value or a value set in advance in the information processing device 600. Alternatively, the determination unit 607 may adaptively (dynamically) change the threshold. In addition, the determination unit 607 may change the threshold for every other user (every indicated position). For example, a distance itself between a viewpoint position of the other user and the indicated position of the other user or a value obtained by multiplying the distance by a coefficient may be used as the threshold. Besides, the threshold may be dynamically determined on the basis of a distance between the own viewpoint and the viewpoint of the other user, a distance between the own viewpoint and the own indicated position, a distance between the own indicated position and the indicated position of the other user, a side or a surface-normal direction of the object 1102, or the like.

In S1008, the UI display control unit 608 makes a change to expression of the indicated position or the object 1102 with a receipt of a determination result of the determination unit 607. When the indicated position of the other user is not seen or hardly seen, the UI display control unit 608 may improve easiness of seeing (visual identification) of the indicated position. At this time, the UI display control unit 608 may make a change to the expression of both or one of the indicated position and the object 1102 to make the indicated position visually conspicuous than the object 1102. That is, visibility of the indicated position is given higher priority than the object 1102. On the other hand, when the indicated position of the other user is seen or easily seen, the UI display control unit 608 may make a change to the expression of both or one of the indicated position and the object 1102 to suppress a reduction in the visibility of the object 1102 due to display of the indicated position. That is the visibility of the object 1102 is given higher priority than the indicated position.

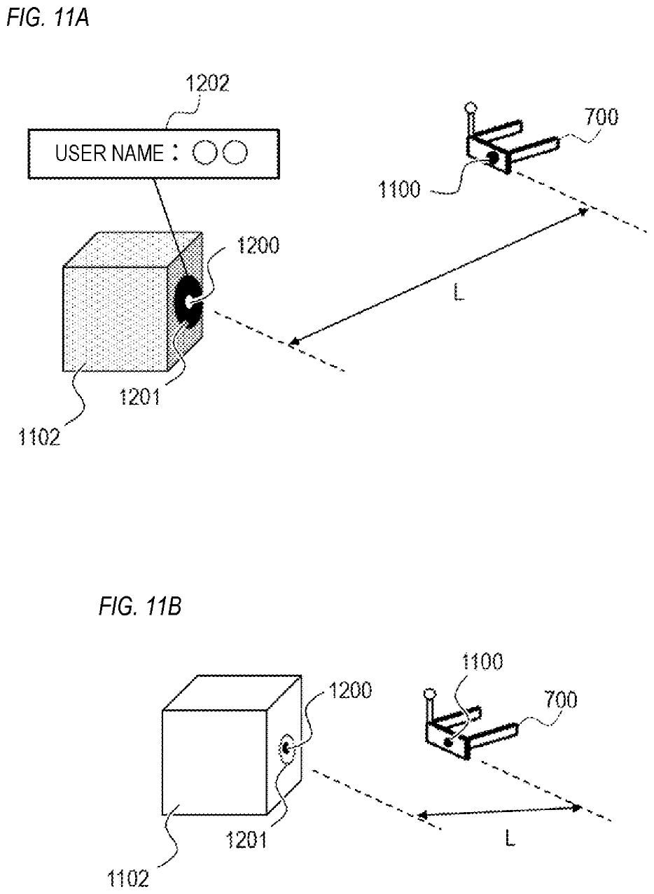

Making a change to expression of an indicated position and an object 1102 will be described using FIGS. 11A and 11B. FIG. 11A shows an example in which a distance L between an own viewpoint 1100 and an indicated position 1200 of another user is determined to be at least a threshold. When the distance L is at least the threshold, expression of a pointer 1201 representing the indicated position 1200 is highlighted in order to improve visibility of the indicated position 1200 of the other user. Specifically, the pointer 1201 is made larger in size than a normal size. Besides, the pointer 1201 may be expressed by a highlighted color, or a highlighting effect such as blinking and animation may be added. Moreover, an annotation 1202 may be added, or the object 1102 on which the pointer 1201 is superimposed may be made semi-transparent. FIG. 11B shows an example in which the distance L between the own viewpoint 1100 and the indicated position 1200 of the other user is determined to be less than the threshold. When the distance L is less than the threshold, the pointer 1201 at the indicated position 1200 is, for example, made smaller in size and expressed only by a frame in order to give higher priority to visibility of the object 1102. Besides, the pointer 1201 at the indicated position 1200 may be made semi-transparent. By making a change to the expression of the pointer 1201 and/or the object 1102 according to the distance L as described above, it is possible to achieve both easiness of grasping the indicated position 1200 of the other user and prevention of a reduction in the visibility of the object 1102.

Note that all or at least one of the changes to the expression of the pointer 1201 and the object 1102 described above may be performed. Of course, another method for making a change to the expression of the pointer 1201 and the object 1102 may be employed. Further, the display of the pointer 1201 and the object 1102 is changed depending on whether the distance Lis at least the threshold in the present embodiment. However, the display may be changed at least at three levels according to the distance L. For example, the pointer 1201 may be made larger in size on a step-by-step basis or the transparency of the object 1102 may be increased as the distance L increases. Conversely, the pointer 1201 may be made smaller in size on a step-by-step basis or the transparency of the pointer 1201 may be increased as the distance L decreases.

In S1009, the image generation unit 609 first constructs a virtual space in which the respective CG contents are arranged using information on the CG content acquired from the retention unit 606, the pointer or the CG content at the indicated position changed by the UI display control unit 608. Then, the image generation unit 609 generates an image of the virtual space seen from the positions and the orientations of the right viewpoint and the left viewpoint calculated in S1002 using the internal parameters of the imaging unit 701. Since a known technology is available as a technology to generate the image of the virtual space seen from the viewpoint, a description relating to the technology will be omitted.

The image generation unit 609 generates an image of a mixed-reality space by synthesizing the generated image of the virtual space and the image of the reality space acquired from the imaging unit 701 together. Synthesizing processing is performed in such a manner as to superimpose the image of the virtual space on the image of the reality space. That is, a synthetic image in which pixels of the reality space are displayed in pixels in regions other than the regions of the CG contents is obtained. At this time, colors or brightness of pixels of an object in the reality space on which the pointer 1201 is superimposed may be changed in order to improve the visibility of the pointer 1201 at the indicated position 1200. When the virtual space is observed, a video signal of a virtual-space image for a right eye is transmitted to a right-eye display, and a video signal of a virtual space image for a left eye is transmitted to a left-eye display. When the mixed-reality space is observed, images of respective mixed-reality spaces are transmitted to the respective displays instead of the respective virtual-space images. Thus, a user (observer) wearing the HMD 700 is enabled to observe the virtual space or the mixed-reality space.

In S1010, a determination is made as to whether the user has input an instruction to end the processing. When the instruction to end the processing has been input, the processing of the flowchart of FIG. 9 ends. Otherwise, the processing returns to S1001.

As described above, according to the present embodiment, it is possible to achieve both easiness of grasping an indicated position of another user and prevention of a reduction in visibility of an object by making a change to the expression of a pointer or a CG content at the indicated position according to a distance between an own viewpoint position and the indicated position of the other user.

### First Modified Example of Second Embodiment

In the second embodiment described above, a change is made to expression of a pointer or CG at an indicated position according to a distance between an own viewpoint position and the indicated position of another user. In the present modified example, a change is made to expression of a pointer or CG at an indicated position on the basis of a relationship between a direction of a surface of the indicated position of another user and an own viewpoint position or a visual-line direction. Hereinafter, descriptions of portions common to the second embodiment will be appropriately omitted, and different portions will be intensively described. In a system according to the present modified example, operations of a determination unit 607 and an UI display control unit 608 are different from those of the second embodiment.

The determination unit 607 determines visibility of an indicated position of another user from an own viewpoint on the basis of a position and an orientation (visual-line direction) of the own viewpoint and the indicated position of the other user and a surface-normal vector at the indicated position.

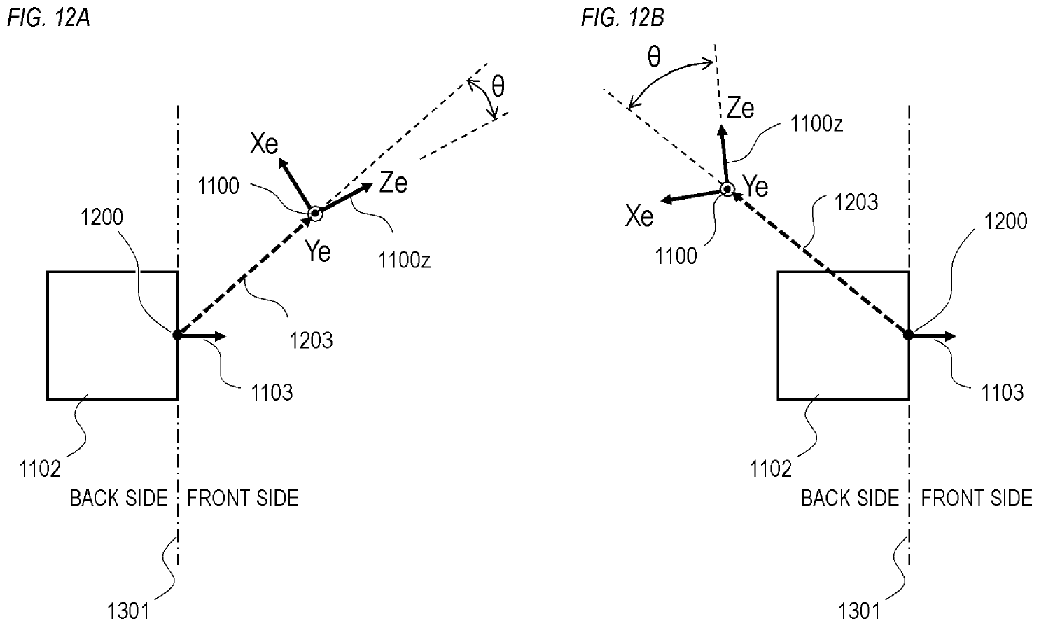

An example of a determination method will be described using FIGS. 12A and 12B. First, the determination unit 607 determines whether a position of a viewpoint 1100 is on a front side or a back side of a surface 1301 calculated from a surface-normal vector 1103 on the basis of the position of the own viewpoint 1100, an indicated position 1200 of another user, and the surface-normal vector 1103. A direction in which the surface-normal vector 1103 is oriented is on the front side of the surface 1301. Next, the determination unit 607 calculates an angle θ formed by a vector 1100z in a Ze-axis positive direction in a viewpoint coordinate system and a vector 1203 directed from the indicated position 1200 toward the position of the own viewpoint 1100.

FIG. 12A shows a case in which the viewpoint 1100 is on the front side of the surface 1301. In this case, when the angle θ falls within the range of −90 degrees to 90 degrees (an absolute value of the angle θ is less than 90 degrees), it is determined that visibility of the indicated position 1200 of the other user from the own viewpoint 1100 is good (seen or easily seen). When the angle θ falls outside the angle range of −90 degrees to 90 degrees (the absolute value of the angle θ is at least 90 degrees), it is determined that the visibility of the indicated position 1200 from the own viewpoint 1100 is poor (not seen or hardly seen).

FIG. 12B shows a case in which the viewpoint 1100 is on the back side of the surface 1301. In this case, when the angle θ falls within the range of −90 degrees to 90 degrees (the absolute value of the angle θ is less than 90 degrees), the indicated position 1200 of the other user falls within an own view. However, since the indicated position 1200 is occluded by an object 1102, it is determined that the indicated position 1200 is not seen. When the angle θ falls outside the range of −90 degrees to 90 degrees (the absolute value of the angle θ is at least 90 degrees), it is determined that the indicated position 1200 is not seen from the own viewpoint 1100.

Note that the angle range (threshold) of the view is set at +90 degrees here. However, the angle range may be set at any range. For example, the angle range may be set on the basis of a user's view angle (for example, a narrow one of a vertical angle of view and a horizontal angle of view of an imaging unit 701). The angle range may be a fixed value or a value set in advance in an information processing device 600 by a user oneself. Alternatively, the determination unit 607 may adaptively (dynamically) change the angle range. In addition, the determination unit 607 may change the angle range for every other user (every indicated position). For example, the angle range may be dynamically determined according to a distance between the own viewpoint 1100 and the indicated position 1200 of another user. Alternatively, the angle range (a threshold as a reference for making a determination) is not changed according to a distance, but a determination result may be changed according to a distance. That is, even where it is determined that an indicated position is “seen or easily seen” when a distance is within a predetermined angle range, the determination result may be changed to a determination result that the indicated position is “not seen or hardly seen” if the distance is at least a threshold.

The UI display control unit 608 makes a change to expression of an indicated position or the object 1102 according to a determination result of the determination unit 607. Specifically, when it is determined that the indicated position 1200 is seen or easily seen, the UI display control unit 608 may make a change to expression of both or one of the indicated position 1200 and the object 1102 so as to suppress a reduction in visibility of the object 1102 due to display of the indicated position 1200. For example, a pointer at the indicated position 1200 may be made smaller in size, or may be expressed only by a frame. Besides, the pointer at the indicated position 1200 may be made semi-transparent.

When it is determined that the indicated position 1200 is present within a view but is occluded by the object 1102, the UI display control unit 608 may make the object 1102 semi-transparent to enable visual recognition of a pointer at the indicated position 1200. Alternatively, an annotation may be added to the indicated position 1200 as shown in FIG. 11A to let a user know the presence of a pointer at the indicated position 1200 on the far side the object 1102. Alternatively, a message “the back side of an object is indicated by another user” may be displayed on a display screen of the HMD 700 to urge a user to move a visual point.

When it is determined that the indicated position 1200 is present within a view but is hardly seen since the indicated position 1200 is distant from a viewpoint, the UI display control unit 608 may highlight expression of a pointer representing the indicated position 1200 in order to improve visibility of the indicated position 1200. Specifically, the pointer may be made larger in size than a normal size or expressed by a highlighted color, a highlighting effect such as blinking and animation may be added, an annotation may be added, or an object on which the pointer is superimposed may be made semi-transparent. Further, a message “indicated by another user” may be displayed on a display screen of the HMD 700 to get user's attention.

As described above, according to the present modified example, it is possible to determine whether an indicated position of another user is seen on the basis of a relationship between a direction of a surface indicated by the other user and an own viewpoint position or a visual-line direction and make a change to expression of a pointer or CG at the indicated position according to the determination. Thus, it is possible to achieve both easiness of grasping the indicated position of the other user and prevention of a reduction in visibility of an object.

### Second Modified Example of Second Embodiment

In the first modified example of the second embodiment described above, a change is made to expression of a pointer or CG at an indicated position in consideration of an own visual-line direction and a direction of a surface at the indicated position of another user. In the present modified example, a change is made to expression of a pointer or CG at an indicated position depending on whether an image of the indicated position of another user is captured by an imaging unit. Hereinafter, descriptions of portions common to the second embodiment and the first modified example of the second embodiment will be appropriately omitted, and a different portion will be intensively described. In a system relating to the present modified example, an operation of a determination unit 607 is different from those of the second embodiment and the first modified example of the second embodiment.

The determination unit 607 determines whether an indicated position of another user is within a view from a position and an orientation of an imaging unit 701 of an HMD 700, internal parameters of the imaging unit 701, and the indicated position of the other user that is received by a transmission/reception unit 605. For example, the determination unit 607 converts the indicated position of the other user in a world coordinate system into positional information in a camera coordinate system of the imaging unit 701. Then, the determination unit 607 converts the positional information in the camera coordinate system into positional information in an image coordinate system by performing perspective projection conversion using the internal parameters of the imaging unit 701. Depending on whether the position in the image coordinate system falls within a range of an image captured by the imaging unit 701, the determination unit 607 is enabled to determine whether the indicated position of the other user is within the view. Since a known technology is available as a technology to determine whether the indicated position of the other user is within the view, a description relating to the technology will be omitted. When the indicated position of the other user is not within the view, the determination unit 607 determines that the indicated position of the other user is not seen from an own viewpoint.

Next, in the same manner as that described in the first modified example of the second embodiment, the determination unit 607 determines whether a position of the own viewpoint is on a front side or a back side of a surface (that is, a surface including the indicated position of the other user) calculated from a surface-normal vector. When the own viewpoint is on the front side of the surface including the indicated position of the other user and that the indicated position of the other user is within the view, the determination unit 607 determines that the indicated position of the other user is seen or easily seen from the own viewpoint. Further, when the own viewpoint is on the back side of the surface including the indicated position of the other user and that the indicated position of the other user is within the view, the determination unit 607 determines that the indicated position of the other user is within the view but is not seen since the indicated position is occluded by an object. Here, even where it is determined that the indicated position of the other user is seen, a determination result may be changed in consideration of a distance between the own viewpoint and the indicated position of the other user as described in the first modified example of the second embodiment. For example, when the distance between the own viewpoint and the indicated position of the other user is at least a threshold even where it is determined that the indicated position of the other user is “seen,” the determination result may be changed to a determination result that the indicated position is “not seen” or “hardly seen since the distance is long.”

A UI display control unit 608 makes a change to expression of a pointer or CG of an object at an indicated position according to a determination result of the determination unit 607. Since a specific method for changing the expression may be the same as those described in the second embodiment and the first modified example of the second embodiment, a detailed description of the method will be omitted.

As described above, according to the present modified example, it is possible to determine whether an indicated position of another user is seen depending on whether an image of the indicated position of the other user is captured by the imaging unit 701 and make a change to a pointer or a CG content at the indicated position according to the determination. Thus, it is possible to achieve both easiness of grasping the indicated position of the other user and prevention of a reduction in visibility of an object.

### Third Modified Example of Second Embodiment

In the second modified example of the second embodiment described above, a determination is made as to whether an indicated position of another user is seen depending on whether an image of the indicated position of the other user is captured by the imaging unit 701, and a change is made to expression of a pointer or a CG content at the indicated position according to the determination. In the present modified example, when an indicated position of another user is seen for a certain time, a change is made to expression of a pointer or a CG content at the indicated position to avoid a reduction in visibility of the CG content. Hereinafter, descriptions of portions common to the second embodiment, the first modified example of the second embodiment, and the second modified example of the second embodiment will be appropriately omitted, and different portions will be intensively described. In a system relating to the present modified example, operations of a determination unit 607 and a UI display control unit 608 are different from those of the second embodiment, the first modified example of the second embodiment, and the second modified example of the second embodiment.

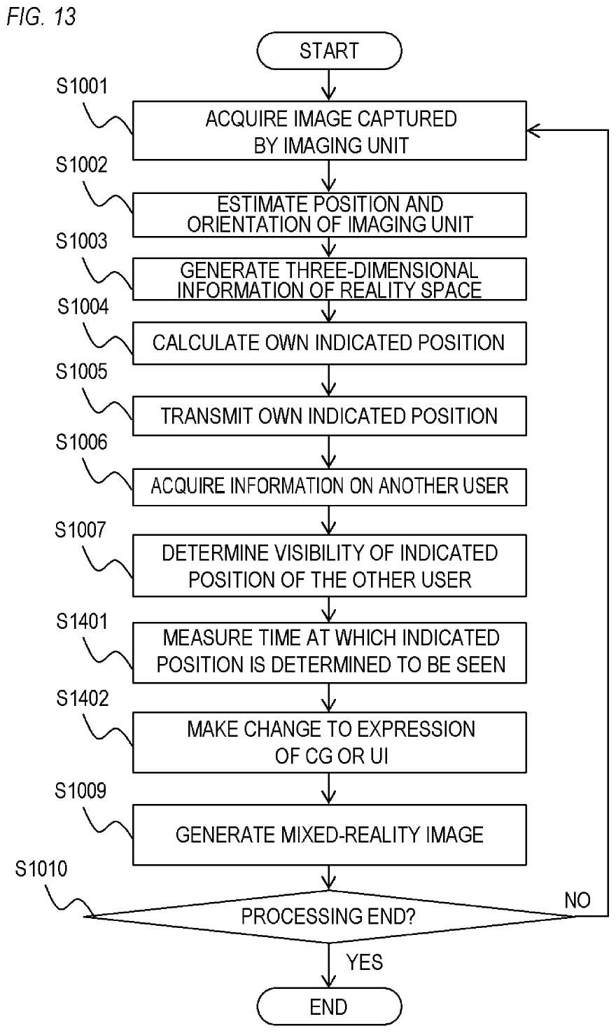

Operations of the respective function units of an information processing device 600 in the present modified example will be described along the flowchart of FIG. 13. FIG. 13 is the flowchart showing a processing procedure of the information processing device 600 in the present modified example. The same step numbers will be assigned to steps common to FIG. 9, and their descriptions will be omitted.

Processing of S1001 to S1007 is the same as that of the second embodiment (FIG. 9). In S1401, the determination unit 607 measures a time at which an indicated position of another user is seen from an own viewpoint. That is, the determination unit 607 calculates a time at which the same determination result is continuously obtained since the time point when it is first determined that the indicated position of the other user is seen from the own viewpoint, and transmits the time information to the UI display control unit 608.

In S1402, the UI display control unit 608 considers the time measured by the determination unit 607 in processing to make a change to expression of a pointer or CG of an object at the indicated position. Specifically, as the time at which the indicated position is seen becomes longer or when the time at which the indicated position is seen exceeds a predetermined threshold, the UI display control unit 608 makes the pointer representing the indicated position inconspicuous to improve visibility of the object. For example, the UI display control unit 608 may gradually increase transparency of the pointer according to a length of the time at which the indicated position is seen.

Alternatively, the UI display control unit 608 may gradually decrease a size of the pointer according to the length of the time at which the indicated position is seen. Finally, the pointer may be made invisible after the transparency is gradually increased or the size is gradually decreased. Alternatively, with an upper limit value of the transparency and a lower limit value of the size set in advance, the UI display control unit 608 may control the transparency and the size so as not to exceed the values. When the time at which the indicated position is seen exceeds a predetermined threshold, the UI display control unit 608 may change the pointer so as to have fixed transparency and/or a fixed size. When the time at which the indicated position is seen exceeds the predetermined threshold, the UI display control unit 608 may make the pointer invisible.

For example, a case where two persons A and B share the same mixed-reality space and discuss while observing the same object (real object or virtual object) will be assumed. When the person A starts explaining while pointing to a position p on the object, the person B recognizes an interest region of the person A by a pointer displayed in a superimposed fashion at the position p on the object. After recognizing the interest region, the person B will want to more deeply observe the position p on the object or its surroundings and feel the pointer displayed in a superimposed fashion on the object as being obstructive. According to the display control of the present modified example, it is highly likely that the person B has recognized the indicated position of the person A when a time at which the pointer of the person A is seen lasts to a certain extent, and therefore the pointer of the person A is made inconspicuous (or invisible). Thus, it is possible to achieve both easiness of grasping the indicated position of the person A and prevention of a reduction in visibility of the object.

### OTHER EMBODIMENTS

The preferred embodiments of the present invention are described above. However, the present invention is not limited to the embodiments and may be modified and changed in various ways within the range of its gist. The configurations described in the first and second embodiments may be combined together (unless any technological contradiction arises).

For example, the embodiments describe examples in which the present invention is applied to a non-transparent or video see-through HMD. However, the present invention may be applied to optical see-through HMDs. Further, the present invention may be applied to display devices that are not a head-mounted type, for example, hand-held display devices, stationary display devices, display devices of computers and smart phones, projector screens, retinal projection displays, or the like.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, it is possible to provide a technology capable of achieving both easiness of grasping an indicated position of another user and prevention of a reduction in visibility in an operation on a three-dimensional space.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-079405, filed on May 12, 2023, which is hereby incorporated by reference herein in its entirety.

What is claimed is:

1. An information processing system comprising:
a processor; and
a memory storing a program that, when executed by the processor, causes the processor to
generate a first image representing a view from a viewpoint of a first user on a virtual three-dimensional space shared by a plurality of users,
synthesize an indication user interface (UI) used by each user to indicate a point in the three-dimensional space with the first image,
determine visibility of an indicated position of a second user when seen from the viewpoint of the first user, the indicated position being a point in the three-dimensional space that is indicated by the second user through the indication UI, and
change a method for displaying the indication UI of the second user in the first image according to a determination result of the visibility.

2. The information processing system according to claim 1, wherein
the visibility of the indicated position of the second user is determined to be good in a case where the indicated position of the second user is at a place seen from the viewpoint of the first user, and determined to be poor in a case where the indicated position of the second user is at a place not seen from the viewpoint of the first user.

3. The information processing system according to claim 1, wherein
the method for displaying the indication UI of the second user in the first image is changed at a time point in a case where a same determination result is continued for a predetermined time after the determination result of the visibility is changed.

4. The information processing system according to claim 1, wherein
the visibility of the indicated position of the second user is determined to be good in a case where the indicated position of the second user is on a front side of an object and determined to be poor in a case where the indicated position of the second user is on a back side of the object, using depth information on the object included in the first image.

5. The information processing system according to claim 1, wherein
the indication UI includes a pointer representing an indicated position that is a point in the three-dimensional space indicated by a user and a ray representing an indicated direction that is a direction indicated by the user, and
a ray of the second user is displayed in a case where the visibility of the indicated position of the second user is determined to be poor, and
the ray of the second user is hidden in a case where the visibility of the indicated position of the second user is determined to be good.

6. The information processing system according to claim 1, wherein
the indication UI includes a pointer representing an indicated position that is a point in the three-dimensional space indicated by a user and a ray representing an indicated direction that is a direction indicated by the user,
a method for displaying a pointer of the second user is changed in a case where the visibility of the indicated position of the second user is determined to be poor, and a ray of the second user is hidden in a case where the visibility of the indicated position of the second user is determined to be good.

7. The information processing system according to claim 1, wherein
control is performed so as to display the indication UI of the second user only when the first user performs a predetermined operation.

8. The information processing system according to claim 1, wherein
in a case where indication UIs of the plurality of users are superimposed on each other on the first image, a method for displaying the indication UIs superimposed on each other is changed.

9. The information processing system according to claim 1, wherein
the visibility of the indicated position of the second user is determined to be poor in a case where a distance between the viewpoint of the first user and the indicated position of the second user is longer than a threshold, and determined to be good in a case where the distance is shorter than the threshold.

10. The information processing system according to claim 9, wherein
the threshold is determined on a basis of a distance between a viewpoint of the second user and the indicated position of the second user.

11. The information processing system according to claim 1, wherein
the visibility of the indicated position of the second user is determined to be good in a case where an angle formed by a visual line of the first user and a line connecting the viewpoint of the first user and the indicated position of the second user falls within a predetermined angle range, and determined to be poor in a case where the angle falls outside the predetermined angle range.

12. The information processing system according to claim 11, wherein
the predetermined angle range is determined on a basis of a view angle of the first user.

13. The information processing system according to claim 1, wherein
a determination is performed as to whether the viewpoint of the first user is on a front side or a back side of an object on a basis of a surface normal of the object at the indicated position of the second user,
the indicated position of the second user is determined to be at a place seen from the viewpoint of the first user in a case where the viewpoint of the first user is on the front side of the object and an angle formed by a visual line of the first user and a line connecting the viewpoint of the first user and the indicated position of the second user falls within a predetermined angle range, and
the indicated position of the second user is determined to fall within the view of the first user but is determined to be hidden from the viewpoint of the first user since the indicated position of the second user is occluded by the object in a case where the viewpoint of the first user is on the back side of the object and the angle falls within the predetermined angle range.

14. The information processing system according to claim 1, wherein
at least one of a size, a shape, and transparency of the indication UI of the second user is changed according to the determination result of the visibility.

15. The information processing system according to claim 1, wherein
an annotation is added to the indication UI of the second user according to the determination result of the visibility.

16. The information processing system according to claim 1, wherein
a message for letting the first user know indication by the second user through the indication UI is displayed according to the determination result of the visibility.

17. The information processing system according to claim 1, wherein
a method for displaying an object at which the indicated position of the second user is located is changed according to the determination result of the visibility.

18. The information processing system according to claim 1, wherein
a time at which the indicated position of the second user is determined to be seen from the viewpoint of the first user is measured, and
a method for displaying the indication UI is changed according to the measured time.

19. An information processing method to be executed by a computer, comprising:
generating a first image representing a view from a viewpoint of a first user on a virtual three-dimensional space shared by a plurality of users;
synthesizing an indication user interface (UI) used by each user to indicate a point in the three-dimensional space with the first image;
determining visibility of an indicated position of a second user when seen from the viewpoint of the first user, the indicated position being a point in the three-dimensional space that is indicated by the second user through the indication UI; and
changing a method for displaying the indication UI of the second user in the first image according to a determination result of the visibility.

20. A non-transitory computer readable medium that stores a program, wherein the program causes a computer to execute an information processing method comprising:
generating a first image representing a view from a viewpoint of a first user on a virtual three-dimensional space shared by a plurality of users;
synthesizing an indication user interface (UI) used by each user to indicate a point in the three-dimensional space with the first image;
determining visibility of an indicated position of a second user when seen from the viewpoint of the first user, the indicated position being a point in the three-dimensional space that is indicated by the second user through the indication UI; and
changing a method for displaying the indication UI of the second user in the first image according to a determination result of the visibility.
